(19) United States
(12) Patent Application Publication
(10) Pub. No.: US 2020/0035161 A1
(43) Pub. Date: Jan. 30, 2020

(54) ORGANIC LIGHT EMITTING DIODE DISPLAY DEVICE AND DRIVING CIRCUIT THEREOF

(71) Applicant: SHENZHEN CHINA STAR OPTOELECTRONICS SEMICONDUCTOR DISPLAY TECHNOLOGY CO., LTD., Shenzhen, Guangdong (CN)

(72) Inventor: Xiaolong CHEN, Shenzhen (CN)

(73) Assignee: SHENZHEN CHINA STAR OPTOELECTRONICS SEMICONDUCTOR DISPLAY TECHNOLOGY CO., LTD., Shenzhen, Guangdong (CN)

(21) Appl. No.: 16/322,075

(22) PCT Filed: Sep. 29, 2018
(86) PCT No.: PCT/CN2018/108533

§ 371 Date: Jan. 30, 2019

(30) Foreign Application Priority Data
Jul. 26, 2018 (CN) 201810836699.3

(51) Int. Cl. G09G 3/3258; G09G 3/3233; G09G 3/3266; G09G 3/3275

(52) U.S. Cl. CPC G09G 3/3258; G09G 3/3275; G09G 3/3266; G09G 3/3233

(57) ABSTRACT

The present invention provides a driving circuit of an organic light emitting diode display device, including: a reference driving circuit for driving an organic light emitting diode to emit light; a compensation circuit for performing voltage compensation on the reference driving circuit; and a data voltage providing circuit for providing a data voltage to the reference driving circuit, wherein the data voltage providing circuit and the compensation circuit are connected to an input end of the reference driving circuit together.

### TECHNICAL FIELD

The present invention generally relates to display technical field, and more particularly, to an organic light emitting diode display device and a driving circuit thereof.

### BACKGROUND ART

In an AMOLED (Active-matrix organic light emitting diode) display device, a reference driving circuit of the AMOLED display device is 2T1C (as shown in FIG. 1) which includes a switch transistor T1, a driving transistor T3 and a storage capacitor Cst, and luminance of each OLED (organic light emitting diode) is determined by a driving current generated by the reference driving circuit, and the driving current generated by the reference driving circuit may be expressed by a following formula:

I_{OLED}=k·(V_{gs}−Vₜₕ)² (1)

where k is a current amplification coefficient related to process parameters and a feature size of the driving transistor and is determined by characteristics of the driving transistor itself, V_{gs} is a voltage difference between a control end of the driving transistor and a second end of the driving transistor, or between the control end and a first end of the driving transistor (determined according to a type of the driving transistor), and Vₜₕ is a threshold voltage of the driving transistor.

Due to instability of a manufacturing process of a panel, threshold voltages Vₜₕ of driving transistors corresponding to respective sub-pixels within the panel may be different, that is to say, even if data voltages Vdata applied to the driving transistors of the respective sub-pixels are equal, a situation in which driving currents I_{OLED} flowing into the OLED are inconsistent may occur so that it is difficult to implement uniformity of a display image quality.

In addition, as a driving time of the driving transistor passes, a material of the transistor may be aged and altered, and this may cause the threshold voltage of the driving transistor to drift. Moreover, since a degree of aging of the transistor material within the panel is different, amount of drift of the threshold voltages of the respective driving transistor within the panel is different, and this may also cause nonuniform phenomenon of the display of the panel; and the aging phenomenon of the transistor material become more severe as the driving time passes; even if the driving voltages are the same, the driving currents flowing into the OLED are probably different, thereby causing the display luminance of the panel to be nonuniform. In addition, the aging of the transistor material may further cause an increase of a turned-on voltage of the driving transistor so that the driving current flowing into the OLED gradually decreases, thereby reducing the luminance and luminous efficiency of the panel.

In order to improve the above phenomenons, the prior art provides a compensation circuit with respect to a threshold voltage of a driving transistor. However, a data line DataLine and a sensing line SenseLine in the current compensation circuit are separated so that an aperture ratio of a display panel is reduced.

### SUMMARY

Exemplary embodiments of the present invention aim to provide a driving circuit of an organic light emitting diode display device to overcome at least one of the above defects.

According to an aspect of the exemplary embodiments of the present invention, a driving circuit of an organic light emitting diode display device is provided, and the driving circuit with respect to each OLED pixel in the OLED device includes: a reference driving circuit for driving an organic light emitting diode to emit light; a compensation circuit for performing voltage compensation on the reference driving circuit; and a data voltage providing circuit for providing a data voltage to the reference driving circuit, wherein the data voltage providing circuit and the compensation circuit are connected to an input end of the reference driving circuit together.

Selectively, the reference driving circuit may include a driving transistor, a storage capacitor and a first switch transistor, wherein a first end of the driving transistor is connected to a power supply voltage, a second end of the driving transistor is connected to a first end of the organic light emitting diode, a second end of the organic light emitting diode is grounded, a control end of the driving transistor is connected to a first end of the first switch transistor, a second end of the first switch transistor as the input end of the reference driving circuit is connected to an output end of the data voltage providing circuit and an output end of the compensation circuit, a control end of the first switch transistor receives a first scan signal, a first end of the storage capacitor is connected to the control end of the driving transistor, and a second end of the storage capacitor is connected to the second end of the driving transistor.

Selectively, the data voltage providing circuit includes a first switch, wherein a first end of the first switch receives the data voltage, and a second end of the first switch as an output end of the data voltage providing circuit is connected to the second end of the first switch transistor.

Selectively, the compensation circuit may include a second switch, a third switch, a first capacitor and an operational amplifier, wherein a positive input end of the operational amplifier receives a reference voltage, an inverse input end of the operational amplifier is connected to a first end of the third switch, a second end of the third switch as the output end of the compensation circuit is connected to the second end of the first switch transistor, a first end of the first capacitor is connected to the inverse input end of the operational amplifier, a second end of the first capacitor is connected to an output end of the operational amplifier, a first end of the second switch is connected to the inverse input end of the operational amplifier, and a second end of the second switch is connected to the output end of the operational amplifier.

Selectively, the first switch transistor may be turned on in response to the control end of the first switch transistor receiving the first scan signal at a valid level; the first switch transistor may be turned off in response to the control end of the first switch transistor receiving the first scan signal at an invalid level, wherein the control end of the driving transistor may be charged in response to the first switch and the first switch transistor being turned on and the second switch and the third switch being turned off so that a voltage of the control end of the driving transistor reaches a sum of the data voltage and the threshold voltage of the driving transistor, and the driving transistor drives the organic light emitting diode to emit light based on the voltage of the control end in response to the first switch transistor being turned off.

Selectively, the driving circuit may further include an initialization voltage providing circuit for providing an initialization voltage, wherein the second end of the driving transistor may be connected to an output end of the initialization voltage providing circuit.

Selectively, the initialization voltage providing circuit may include a second switch transistor, wherein a first end of the second switch transistor may receive the initialization voltage, a second end of the second switch transistor as the output end of the initialization voltage providing circuit may be connected to the second end of the driving transistor, and a control end of the second switch transistor may receive a second scan signal.

Selectively, the threshold voltage may be determined by a sum of a first intermediate voltage and a second intermediate voltage, wherein the first intermediate voltage may be a difference between a reference voltage and the initialization voltage, and the second intermediate voltage may be a product of a difference between an output voltage of the operational amplifier and the reference voltage and a ratio of a capacitance value of the first capacitor to a capacitance value of the storage capacitor.

Selectively, the driving circuit may further include a second capacitor and a third capacitor, wherein a first end of the second capacitor may be grounded, a second end of the second capacitor may be connected to the second end of the first switch transistor, a first end of the third capacitor may be connected to the second end of the storage capacitor, and a second end of the third capacitor may be grounded.

Adopting the above driving circuit of the organic light emitting diode display device may not only improve uniformity and luminous efficiency of the display of the panel, but also improve an aperture ratio of the panel effectively.

### BRIEF DESCRIPTION OF THE DRAWINGS

FIG. 1 shows a circuit diagram of a driving circuit of an existing organic light emitting diode display device;

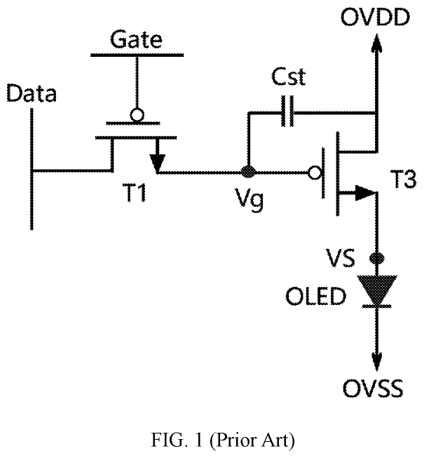

FIG. 2 shows a circuit diagram of a driving circuit of any sub-pixel according to an exemplary embodiment of the present invention;

FIG. 3 shows a timing control diagram of the driving circuit of any sub-pixel as shown in FIG. 2 being in a display mode according to the exemplary embodiment of the present invention;

FIG. 4 shows working states of respective switches of the driving circuit of any sub-pixel as shown in FIG. 2 being in a first stage of the display mode according to the exemplary embodiment of the present invention;

FIG. 5 shows working states of respective switches of the driving circuit of any sub-pixel as shown in FIG. 2 being in a second stage of the display mode according to the exemplary embodiment of the present invention;

FIG. 6 shows a timing control diagram of the driving circuit of any sub-pixel as shown in FIG. 2 being in a sensing mode according to the exemplary embodiment of the present invention;

FIG. 7 shows working states of respective switches of the driving circuit of any sub-pixel as shown in FIG. 2 being in a first stage of the sensing mode according to the exemplary embodiment of the present invention;

FIG. 8 shows working states of respective switches of the driving circuit of any sub-pixel as shown in FIG. 2 being in a second stage of the sensing mode according to the exemplary embodiment of the present invention; and

FIG. 9 shows working states of respective switches of the driving circuit of any sub-pixel as shown in FIG. 2 being in a third stage of the sensing mode according to the exemplary embodiment of the present invention.

### DETAILED DESCRIPTION OF EXEMPLARY EMBODIMENTS

Here, the exemplary embodiments of the present invention will be described in detail, and embodiments of the present invention are exampled in the drawings. Hereinafter, the present invention is explained by describing the embodiments with reference to the drawings. However, the present invention may be implemented in numerous different forms, and may not be explained to be limited to the exemplary embodiments illustrated here. On the contrary, the present invention will be thorough and complete by providing these embodiments, and these embodiments will convey the scope of the present invention to those skilled in the art sufficiently.

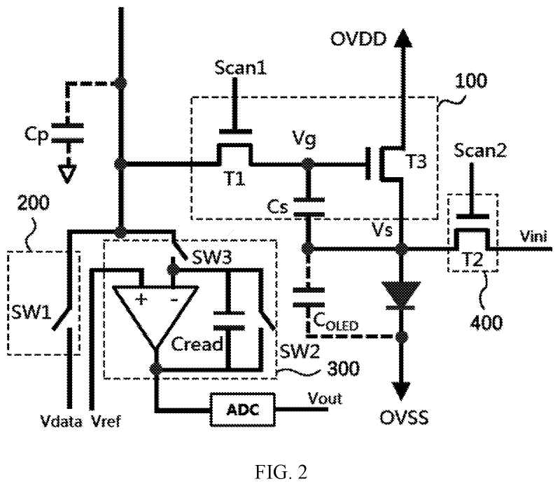

A driving circuit of an organic light emitting diode display device according to an exemplary embodiment of the present invention is used to drive an organic light emitting diode to emit light. It should be understood as that the OLED display device includes a plurality of OLED pixels, and each of the OLED pixels may include a plurality of sub-pixels. As an example, the plurality of sub-pixels may include a red sub-pixel (R), a green sub-pixel (G), and a blue sub-pixel (B). Here, in the exemplary embodiments of the present invention, a circuit structure and a working principle of the driving circuit of the OLED display device is introduced in detail by taking a driving circuit of any sub-pixel as shown in FIG. 2 as an example.

FIG. 2 shows a circuit diagram of a driving circuit of any sub-pixel according to an exemplary embodiment of the present invention

As shown in FIG. 2, the driving circuit of any sub-pixel according to the exemplary embodiment of the present invention includes a reference driving circuit 100 for driving the OLED to emit light, a data voltage providing circuit 200 for providing a data voltage Vdata to the reference driving circuit 100, and a compensation circuit 300 for performing voltage compensation on the reference driving circuit 100. Here, the data voltage providing circuit 200 and the compensation circuit 300 are connected to an input end of the reference driving circuit 100 together. For example, the data voltage providing circuit 200 and the compensation circuit 300 may be connected to the input end of the reference driving circuit 100 by sharing one circuit wiring to efficiently improve an aperture ratio of a panel.

For example, the reference driving circuit 100 may include a driving transistor T3, a storage capacitor Cs, and a first switch transistor T1. Specifically speaking, a first end of a driving transistor T3 is connected to a power supply voltage OVDD, a second end of the driving transistor T3 as an output end of the reference driving circuit 100 is connected to a first end of the OLED, a second end of the OLED is connected to a ground OVSS (or may be connected to a negative electrode of the power supply voltage), a control end of the driving transistor T3 is connected to a first end of the first switch transistor T1, a second end of the first switch transistor T1 as the input end of the reference driving circuit 100 is connected to an output end of the data voltage providing circuit 200 and an output end of the compensation circuit 300, a control end of the first switch transistor T1 receives a first scan signal Scan1, a first end of the storage capacitor Cs is connected to the control end of the driving transistor T3, and a second end of the storage capacitor Cs is connected to the second end of the driving transistor T3. In this case, the compensation circuit 300 is used to compensate a threshold voltage of the driving transistor T3.

Preferably, the data voltage providing circuit 200 may include a first switch SW1, wherein a first end of the first switch SW1 as an input end of the data voltage providing circuit 200 may receive the data voltage Vdata, and a second end of the first switch SW1 as the output end of the data voltage providing circuit 200 may be connected to the second end of the first switch transistor T1.

The compensation circuit 300 may include a second switch SW2, a third switch SW3, a first capacitor Cread, and an operational amplifier. Specifically, a positive input end of the operational amplifier as an input end of the compensation circuit 300 may receive a reference voltage Vref, an inverse input end of the operational amplifier is connected to a first end of the third switch SW3, a second end of the third switch SW3 as the output end of the compensation circuit 300 is connected to the second end of the first switch transistor T1, a first end of the first capacitor Cread is connected to the inverse input end of the operational amplifier, a second end of the first capacitor Cread is connected to an output end of the operational amplifier, a first end of the second switch SW2 is connected to the inverse input end of the operational amplifier, and a second end of the second switch SW2 is connected to the output end of the operational amplifier. As an example, the output end of the operational amplifier may be connected to an analog/digital converter ADC to perform analog-digital conversion on an output voltage of the operational amplifier.

Here, the driving transistor T3 may be turned on according to a voltage difference between the control end and the second end. The first switch transistor T1 may be turned on in response to a valid level of the first scan signal Scan1 received by the control end of the first switch transistor T1. The valid level of the first scan signal Scan1 may be one of a high level and a low level, and an invalid level of the first scan signal Scan1 may be the other one of the high level and the low level. For example, the first switch transistor T1 may be turned on in response to the control end of the first switch transistor T1 receiving the first scan signal Scan1 at the valid level, and the first switch transistor T1 may be turned off in response to the control end of the first switch transistor T1 receiving the first scan signal Scan1 at the invalid level.

Specifically speaking, the control end of the driving transistor T3 may be charged in response to the first switch SW1 and the first switch transistor T1 being turned on and the second switch SW2 and the third switch SW3 being turned off so that a voltage of the control end of the driving transistor T3 reaches a sum of the data voltage Vdata and the threshold voltage Vth of the driving transistor. Thereafter, the driving transistor T3 drives the OLED to emit light based on the voltage of the control end in response to the first switch transistor T1 being turned off.

Preferably, the driving circuit of any sub-pixel according to the exemplary embodiment of the present invention may further include an initialization voltage providing circuit 400 for providing an initialization voltage Vini, wherein the second end of the driving transistor T3 is connected to an output end of the initialization voltage providing circuit 400. Here, since the initialization voltage Vini provided to each of sub-pixels is the same and does not vary over time, the initialization voltage may be input to the entire panel within the panel, that is, the initialization voltages of all the sub-pixels in the panel share one wiring without a separate wiring for each of the sub-pixels. Thus, the aperture ratio of the panel may be further improved.

For example, the initialization voltage providing circuit 400 may include a second switch transistor T2, wherein a first end of the second switch transistor T2 as an input end of the initialization voltage providing circuit receives the initialization voltage Vini, a second end of the second switch transistor T2 as the output end of the initialization voltage providing circuit is connected to the second end of the driving transistor T3, and a control end of the second switch transistor T2 receives a second scan signal Scan2.

Here, the second switch transistor T2 may be turned on in response to a valid level of the second scan signal Scan2 received by the control end of the second switch transistor T2. The valid level of the second scan signal Scan2 may be one of a high level and a low level, and an invalid level of the second scan signal Scan2 may be the other one of the high level and the low level. For example, the second switch transistor T2 may be turned on in response to the control end of the second switch transistor T2 receiving the second scan signal Scan2 at the valid level, and the second switch transistor T2 may be turned off in response to the control end of the second switch transistor receiving the second scan signal Scan2 at the invalid level.

Preferably, the driving circuit of any sub-pixel according to the exemplary embodiment of the present invention may further include a second capacitor Cp and a third capacitor C_{OLED}, wherein a first end of the second capacitor Cp is grounded, a second end of the second capacitor Cp is connected to the second end of the first switch transistor T1, a first end of the third capacitor C_{OLED} is connected to the second end of the storage capacitor Cs, and a second end of the third capacitor C_{OLED} is grounded (i.e., connected to the second end of the OLED).

As an example, the first switch SW1, the second switch SW2 and the third switch SW3 may be turned on and off based on an output voltage of a timing controller. For example, the first switch SW1, the second switch SW2 and the third switch SW3 may be integrated in the panel (i.e., disposed at a panel end), or may be disposed in an integrated circuit (i.e., disposed at an IC end). As an example, the first scan signal Scan1 and the second scan signal Scan2 may be provided by a gate driver.

It should be understood as that the driving circuit of any sub-pixel according to the exemplary embodiment of the present invention may be worked in a display mode. Here, the display mode may include two stages which are a data voltage Vdata writing stage and an OLED luminescence display stage, respectively.

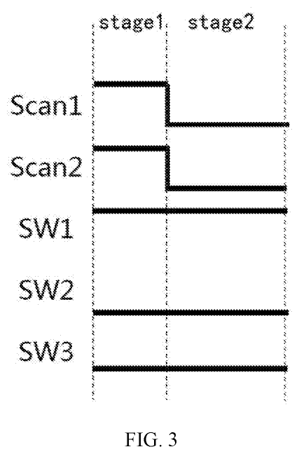

Below, a working principle of the driving circuit of any sub-pixel as shown in FIG. 2 being in the display mode is introduced in conjunction with the timing control diagram illustrated in FIG. 3.

FIG. 3 shows a timing control diagram of the driving circuit of any sub-pixel as shown in FIG. 2 being in a display mode according to the exemplary embodiment of the present invention.

In an example illustrated in FIG. 3, if the valid levels of the first scan signal Scan1 and the second scan signal Scan2 are the high levels, the first switch SW1, the second switch SW2 and the third switch SW3 all are turned on at high-level.

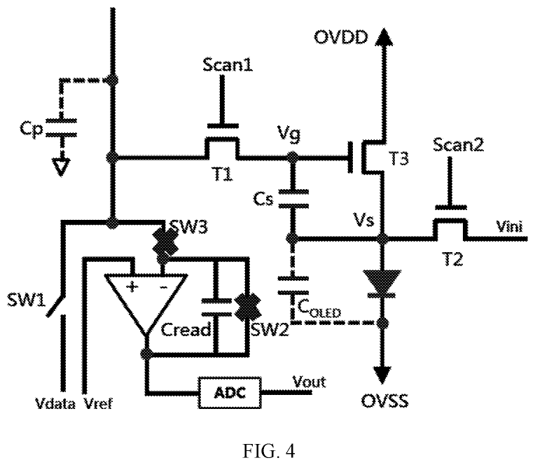

First stage: the data voltage Vdata writing stage. FIG. 4 shows working states of respective switches of the driving circuit of any sub-pixel as shown in FIG. 2 being in a first stage of the display mode according to the exemplary embodiment of the present invention.

As shown in FIG. 4, the second switch transistor T2 is turned on in response to the control end of the second switch transistor T2 receiving the second scan signal Scan2 at the high level so that a voltage Vs of the second end of the driving transistor T3 reaches the initialization voltage Vini, that is, Vs=Vini.

Meanwhile, the first switch transistor T1 is turned on in response to the control end of the first switch transistor T1 receiving the first scan signal Scan1 at the high level, at the moment, the first switch SW1 is turned on and the second switch SW2 and the third switch SW3 are turned off, and in this case, the control end of the driving transistor T3 is charged so that the voltage Vg of the control end of the driving transistor T3 reaches a sum of the data voltage Vdata, the threshold voltage Vth of the driving transistor, and the initialization voltage Vini, that is, Vg=Vdata+Vth+Vini.

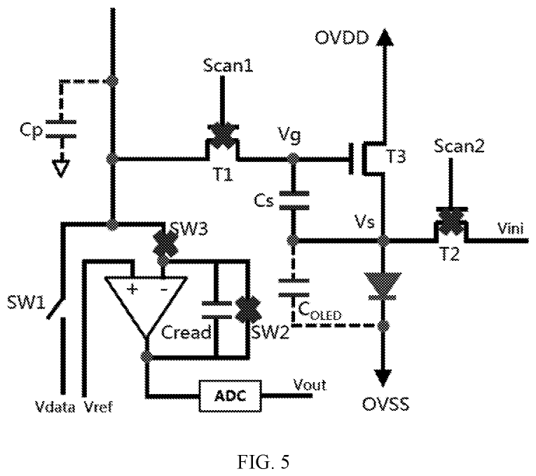

Second stage: the OLED luminescence display stage. FIG. 5 shows working states of respective switches of the driving circuit of any sub-pixel as shown in FIG. 2 being in a second stage of the display mode according to the exemplary embodiment of the present invention.

As shown in FIG. 5, the first switch transistor T1 is turned off in response to the control end of the first switch transistor T1 receiving the first scan signal Scan1 at the low level; and the second switch transistor T2 is turned off in response to the control end of the second switch transistor T2 receiving the second scan signal Scan2 at the low level, at the moment, the first switch SW1 is turned on and the second switch SW2 and the third switch SW3 are turned off, the driving transistor T3 drives the OLED to emit light based on the voltage Vg of the control end.

In this case, a driving current flowing into the OLED may be obtained through a calculation based on the above formula (1):

$${I}_{OLED} = k \cdot {( {V}_{gs} - {V}_{th} )}^{2} = k \cdot {( {V}_{g} - {V}_{s} - {V}_{th} )}^{2} = k \cdot {( {V}_{data} + {V}_{th} + {V}_{ini} - {V}_{ini} - {V}_{th} )}^{2} = k \cdot {( {V}_{data} )}^{2}$$

Accordingly, the driving circuit of any sub-pixel according to the exemplary embodiment of the present invention makes the driving current I_{OLED} be merely associated with the data voltage Vdata but not associated with the threshold voltage Vth of the driving transistor T3. That is to say, an influence of the threshold voltage Vth on the OLED is eliminated, thereby effectively improving the uniformity and luminous efficiency of the display of the panel.

It should be understood as that the driving circuit of any sub-pixel according to the exemplary embodiment of the present invention may also work in a sensing mode. Here, the sensing mode may include three stages which are a potential initializing stage, a threshold voltage storing stage and a sensing stage, respectively.

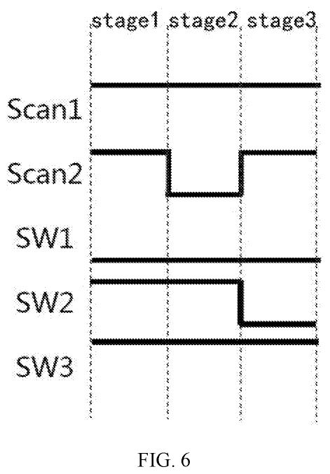

Below, a working principle of the driving circuit of any sub-pixel as shown in FIG. 2 being in the sensing mode is introduced in conjunction with the timing control diagram illustrated in FIG. 6.

FIG. 6 shows a timing control diagram of the driving circuit of any sub-pixel as shown in FIG. 2 being in a sensing mode according to the exemplary embodiment of the present invention.

In an example illustrated in FIG. 6, assuming that the valid levels of the first scan signal Scan1 and the second scan signal Scan2 are the high levels, the first switch SW1, the second switch SW2 and the third switch SW3 all are turned on at high-level.

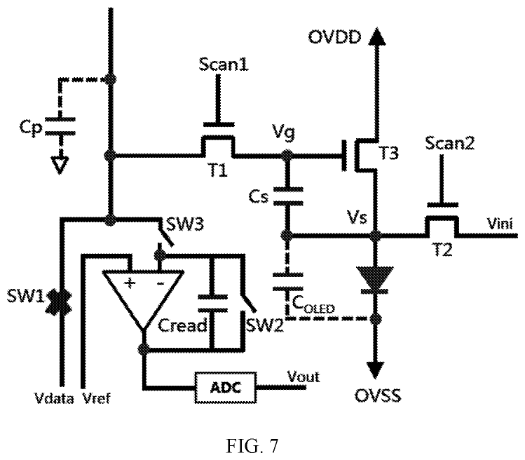

First stage: the potential initializing stage. FIG. 7 shows working states of respective switches of the driving circuit of any sub-pixel as shown in FIG. 2 being in the first stage of the sensing mode according to the exemplary embodiment of the present invention.

As shown in FIG. 7, the first switch transistor T1 is turned on in response to the control end of the first switch transistor T1 receiving the first scan signal Scan1 at the high level, at the moment, the first switch SW1 is turned off and the second switch SW2 and the third switch SW3 are turned on, and in this case, the control end of the driving transistor T3 is charged, and the operational amplifier servers as a voltage follower, so that the voltage Vg of the control end of the driving transistor T3 reaches the reference voltage Vref, that is, Vg=Vref.

Meanwhile, the second switch transistor T2 is turned on in response to the control end of the second switch transistor T2 receiving the second scan signal Scan2 at the high level so that the voltage Vs of the second end of the driving transistor T3 reaches the initialization voltage Vini, that is, Vs=Vini.

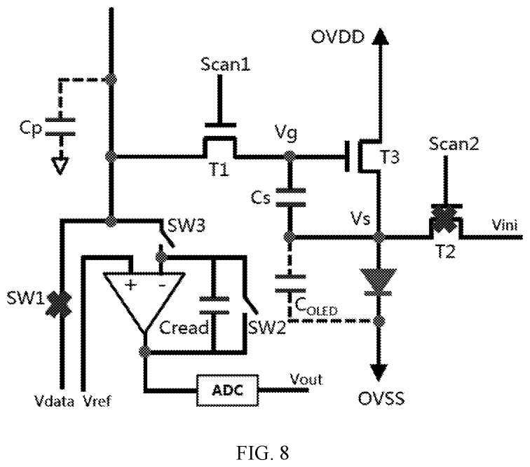

Second stage: the threshold voltage storing stage. FIG. 8 shows working states of respective switches of the driving circuit of any sub-pixel as shown in FIG. 2 being in the second stage of the sensing mode according to the exemplary embodiment of the present invention.

As shown in FIG. 8, the first switch SW1, the second switch SW2, the third switch SW3 and the first switch transistor T1 maintain the previous states so that the voltage Vg of the control end of the driving transistor T3 is maintained as same as the voltage Vg of the control end at the first stage, and both are the reference voltage Vref, that is, Vg=Vref.

Meanwhile, the second switch transistor T2 is turned off in response to the control end of the second switch transistor T2 receiving the second scan signal Scan2 at the low level, the power supply voltage OVDD charges the second end of the driving transistor T3 until the voltage difference between the control end and the second end of the driving transistor T3 reaches the threshold voltage Vth. That is, at the time, the voltage Vs of the second end of the driving transistor T3 reaches the difference between the reference voltage Vref and the threshold voltage Vth, i.e., Vs=Vref-Vth.

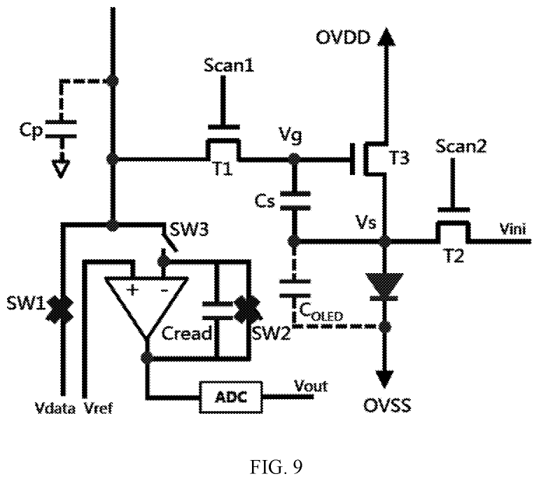

Third stage: the sensing stage. FIG. 9 shows working states of respective switches of the driving circuit of any sub-pixel as shown in FIG. 2 being in the third stage of the sensing mode according to the exemplary embodiment of the present invention.

As shown in FIG. 9, the second switch transistor T2 is turned on in response to the control end of the second switch transistor T2 receiving the second scan signal Scan2 at the high level so that the voltage Vs of the second end of the driving transistor T3 becomes the initialization voltage Vini, that is, Vs=Vini.

Meanwhile, the first switch transistor T1 is turned on in response to the control end of the first switch transistor T1 receiving the first scan signal Scan1 at the high level, at the moment, the third switch SW3 is turned on and the first switch SW1 and the second switch SW2 are turned off, and a following expression formula may be obtained according to a law of conservation of charge:

[Vᵢₙᵢ−(V_{ref}−Vₜₕ)]·Cₛ=(Vₒᵤₜ−V_{ref})·C_{read} (2)

The threshold voltage Vth of the driving transistor T3 may be determined according to the above formula (2), wherein the threshold voltage Vth is a sum of the first intermediate voltage and the second intermediate voltage, the first intermediate voltage may be a difference between the reference voltage Vref and the initialization voltage Vini, and the second intermediate voltage may be a product of a difference between an output voltage Vout of the operational amplifier and the reference voltage Vref and a ratio of a capacitance value of the first capacitor Cread to a capacitance value of the storage capacitor Cs, that is, the threshold voltage Vth may be expressed by a following formula:

$${V}_{th} = {V}_{ref} - {V}_{ini} + ( {V}_{out} - {V}_{ref} ) \cdot \frac{{C}_{read}}{{C}_{s}} \qquad ( 3 )$$

Here, after the threshold voltage Vth is determined through the formula (3), the voltage Vg of the control end of the driving transistor T3 may be enabled to reach the sum of the data voltage Vdata, the initialization voltage Vini and the determined threshold voltage Vth at the first stage of the display mode.

It should be understood as that the V_{gs} may be a voltage difference between a gate electrode and a source electrode of the driving transistor T3, or between the gate electrode and a drain electrode of the driving transistor T3 (determined according to a type of the driving transistor). In addition, in the above exemplary embodiment of the present invention, the driving transistor T3 may be a driving TFT transistor, and the first switch transistor T1 and the second switch transistor T2 both may be switch TFT transistors. Here, the driving circuit of any sub-pixel as shown in FIG. 2 is merely an example. Those skilled in the art may change the type of the respective switches and the corresponding connection relationship in the circuit according to the needs as long as the OLED sub-pixel can be driven to emit light.

Adopting the above driving circuit of the OLED display device according to the exemplary embodiment of the present invention enables the driving current flowing through the OLED to not change with the drifting of the threshold voltage of the driving transistor so that the uniformity and luminous efficiency of the display of the panel can be improved.

In addition, adopting the above driving circuit of the OLED display device according to the exemplary embodiment of the present invention may compensate the threshold voltage of the driving transistor, and may avoid bad display effect caused by problems of the manufacturing process/the aging of the driving transistor.

In addition, adopting the above driving circuit of the OLED display device according to the exemplary embodiment of the present invention makes the data voltage providing circuit and the compensation circuit share one wiring, and the aperture ratio of the panel is improved effectively.

In addition, adopting the above driving circuit of the OLED display device according to the exemplary embodiment of the present invention makes the initialization voltage input to an entire panel in the panel without separate wiring for each of sub-pixels, and this further improves the aperture ratio of the panel.

The present invention has been described with reference to exemplary embodiments above, however, the implementation of the present invention is not limited hereto. Those skilled in the art may make various changes and modifications to the invention without departing from the scope and spirit of the invention, and these changes and modifications will fall within the protection scope defined by the claims.

What is claimed is:

1. A driving circuit of an organic light emitting diode display device, wherein the driving circuit comprises:
a reference driving circuit for driving an organic light emitting diode to emit light;
a compensation circuit for performing voltage compensation on the reference driving circuit; and
a data voltage providing circuit for providing a data voltage to the reference driving circuit,
wherein the data voltage providing circuit and the compensation circuit are connected to an input end of the reference driving circuit together.

2. The driving circuit of claim 1, wherein the reference driving circuit comprises a driving transistor, a storage capacitor, and a first switch transistor,
wherein a first end of the driving transistor is connected to a power supply voltage, a second end of the driving transistor is connected to a first end of the organic light emitting diode, a second end of the organic light emitting diode is grounded, a control end of the driving transistor is connected to a first end of the first switch transistor, a second end of the first switch transistor as the input end of the reference driving circuit is connected to an output end of the data voltage providing circuit and an output end of the compensation circuit, a control end of the first switch transistor receives a first scan signal, a first end of the storage capacitor is connected to the control end of the driving transistor, and a second end of the storage capacitor is connected to the second end of the driving transistor.

3. The driving circuit of claim 2, wherein the data voltage providing circuit comprises a first switch, a first end of the first switch receiving the data voltage, and a second end of the first switch as an output end of the data voltage providing circuit being connected to the second end of the first switch transistor.

4. The driving circuit of claim 2, wherein the compensation circuit comprises a second switch, a third switch, a first capacitor, and an operational amplifier,
wherein a positive input end of the operational amplifier receives a reference voltage, an inverse input end of the operational amplifier is connected to a first end of the third switch, a second end of the third switch as the output end of the compensation circuit is connected to the second end of the first switch transistor, a first end of the first capacitor is connected to the inverse input end of the operational amplifier, a second end of the first capacitor is connected to an output end of the operational amplifier, a first end of the second switch is connected to the inverse input end of the operational amplifier, and a second end of the second switch is connected to the output end of the operational amplifier.

5. The driving circuit of claim 3, wherein the compensation circuit comprises a second switch, a third switch, a first capacitor, and an operational amplifier,
wherein a positive input end of the operational amplifier receives a reference voltage, an inverse input end of the operational amplifier is connected to a first end of the third switch, a second end of the third switch as the output end of the compensation circuit is connected to the second end of the first switch transistor, a first end of the first capacitor is connected to the inverse input end of the operational amplifier, a second end of the first capacitor is connected to an output end of the operational amplifier, a first end of the second switch is connected to the inverse input end of the operational amplifier, and a second end of the second switch is connected to the output end of the operational amplifier.

6. The driving circuit of claim 2, wherein the first switch transistor is turned on in response to the control end of the first switch transistor receiving the first scan signal at a valid level, and the first switch transistor is turned off in response to the control end of the first switch transistor receiving the first scan signal at an invalid level,
wherein the control end of the driving transistor is charged in response to the first switch and the first switch transistor being turned on and the second switch and the third switch being turned off so that a voltage of the control end of the driving transistor reaches a sum of the data voltage and the threshold voltage of the driving transistor, and
the driving transistor drives the organic light emitting diode to emit light based on the voltage of the control end in response to the first switch transistor being turned off.

7. The driving circuit of claim 2, wherein the driving circuit further comprises an initialization voltage providing circuit for providing an initialization voltage, wherein the second end of the driving transistor is connected to an output end of the initialization voltage providing circuit.

8. The driving circuit of claim 7, wherein the initialization voltage providing circuit comprises a second switch transistor,
wherein a first end of the second switch transistor receives the initialization voltage, a second end of the second switch transistor as the output end of the initialization voltage providing circuit is connected to the second end of the driving transistor, and a control end of the second switch transistor receives a second scan signal.

9. The driving circuit of claim 8, wherein the threshold voltage is determined by a sum of a first intermediate voltage and a second intermediate voltage, wherein the first intermediate voltage is a difference between a reference voltage and the initialization voltage, and the second intermediate voltage is a product of a difference between an output voltage of the operational amplifier and the reference voltage and a ratio of a capacitance value of the first capacitor to a capacitance value of the storage capacitor.

10. The driving circuit of claim 8, wherein the driving circuit further comprises a second capacitor and a third capacitor,
wherein a first end of the second capacitor is grounded, a second end of the second capacitor is connected to the second end of the first switch transistor, a first end of the third capacitor is connected to the second end of the storage capacitor, and a second end of the third capacitor is grounded.

11. An organic light emitting diode display device comprising the driving circuit of claim 1.
